(19) United States
(12) Patent Application Publication
(10) Pub. No.: US 2025/0314999 A1
(43) Pub. Date: Oct. 9, 2025

(54) IMAGE FORMING APPARATUS, METHOD FOR DETERMINING ABNORMALITY OF SENSOR IN IMAGE FORMING APPARATUS, AND RECORDING MEDIUM

(71) Applicant: Konica Minolta, Inc., Tokyo (JP)

(72) Inventors: Hirotada Seki, Toyokawa-shi (JP); Yukinobu Iguchi, Hamamatsu-shi (JP); Masahiro Nonoyama, Toyokawa-shi (JP); Hiroshi Eguchi, Toyohashi-shi (JP); Haruki Nakamura, Toyokawa-shi (JP)

(73) Assignee: Konica Minolta, Inc., Tokyo (JP)

(21) Appl. No.: 19/097,078

(22) Filed: Apr. 1, 2025

(30) Foreign Application Priority Data
Apr. 3, 2024 (JP) 2024-060216

(51) Int. Cl. G03G 15/00

(52) U.S. Cl. CPC G03G 15/55; G03G 15/50; G03G 15/80

(57) ABSTRACT

An image forming apparatus includes: a plurality of sensors that detect a state in the image forming apparatus; a power supply that supplies power to each of the plurality of sensors; a current detector that detects a current value of a current supplied from the power supply to each of the plurality of sensors; an acquisitor that acquires, as a reference value, a current value of a current supplied from the power supply to each of the plurality of sensors in a state in which the plurality of sensors are normal, and a determiner that determines whether the plurality of sensors are normal, by comparing the current value detected by the current detector with the reference value.

### CROSS-REFERENCE TO RELATED APPLICATION

The disclosure of Japanese Patent Application No. 2024-060216 filed on Apr. 3, 2024, including description, claims, drawings, and abstract, is incorporated herein by reference in its entirety.

### BACKGROUND OF THE INVENTION

### 1. Technical Field

The present invention relates to an image forming apparatus such as a copier, a printer, or a multi-function peripheral, a method for determining an abnormality of a sensor in the image forming apparatus, and a recording medium.

### 2. Description of Related Art

In an image forming apparatus such as that described above, a plurality of sensors such as a sheet passage sensor for detecting that a conveyed sheet has passed, and a detection sensor for detecting a characteristic of the sheet are used.

An abnormality may occur in the sensor due to a malfunction of the sensor, a connection failure with a connector, or the like. In order to confirm whether such a sensor is normal or abnormal, the following is considered. That is, as illustrated in FIG. 5, in a case where the sensor is, for example, a sensor 20 including a light emitting element 20a and a light receiving element 20b, a controller 30 including a CPU may turn on/off the light emitting element 20a formed of an LED and check whether there is a change in the output of the light receiving element 20b.

However, as illustrated in FIG. 6, a light shielding object 200 may be disposed between the light emitting element 20a and the light receiving element 20b to shield light. Further, when the sensor is a reflective sensor, a reflective object may not be present. In such a case, the presence or absence of an abnormality cannot be confirmed because the output of the light receiving elements 20b does not change even when the light emitting element 20a is turned on/off.

Further, by measuring the current flowing through one sensor, it is possible to detect a connection failure with a connector or a malfunction of a light emitting unit. However, since a plurality of sensors are used, if a current detection circuit is provided for each sensor, a huge number of ports and circuits are required.

Further, as illustrated in FIG. 6, when the current values of the plurality of sensors 20 are detected by one current detection circuit and the abnormality of each sensor is detected only by the change of the detected current value, the following problem arises. That is, there is a problem that it is difficult to detect whether one sensor is abnormal because the minimum current varies due to a variation in circuit constant or an individual difference of the sensors.

To be more specific, it is assumed that, in a power supply system including ten sensors through which a current with a representative current value of 12 mA flows, when a total current value of 120 mA is detected, it is determined that the sensors are normal, and when a total current value of 108 mA is detected, it is determined that one of the sensors is abnormal.

However, there is a possibility that a minimum current value is 9.2 mA with respect to the representative current value of 12 mA due to the variation in circuit constant and the individual difference of the sensors. In this case, even if the ten sensors through which the current with the minimum current value of 9.2 mA flows are normal, a total current value is 92 mA (9.2×10), and it is not possible to determine whether one of the sensors is abnormal.

Japanese Unexamined Patent Application Publication No. H05-026937 discloses an image forming apparatus that, in response to a change in output of control signals to a plurality of controlled objects, detects an amount of currents flowing through the controlled objects and determines, based on the detected amount of currents, whether control signal output means is normal or abnormal.

In Japanese Unexamined Patent Application Publication No. 2020-078876, an image forming apparatus is disclosed in which a current detection resistor is provided in a power supply line of a sheet detection sensor, and a current flowing through the current detection resistor is detected, thereby identifying a malfunction of the sheet detection sensor based on the detected current. In this image forming apparatus, a timing at which a current flows through the sheet detection sensor and a timing at which a current flows through the current detection resistor are switched by an FET which is a switch element.

However, in the image forming apparatus described in Japanese Unexamined Patent Application Publication No. H05-026937, the amount of currents flowing through the plurality of controlled objects is detected in response to switching of output of control signals to the controlled objects. Therefore, the abnormality determination is performed for each of the plurality of controlled objects, which leads to a problem that the abnormality determination processing is complicated.

Further, in the image forming apparatus described in Japanese Unexamined Patent Application Publication No. 2020-078876, a current detection resistor is required for each sheet detection sensor, and the circuit becomes enormous. Furthermore, since the timing at which the current flows through the sheet detection sensor and the timing at which the current flows through the current detection resistor are switched, there is also a problem that the abnormality determination processing is complicated.

### SUMMARY OF THE INVENTION

An object of the present invention is to provide an image forming apparatus that can accurately determine, with simple processing, whether a plurality of sensors are normal, a method for determining an abnormality of a sensor in the image forming apparatus, and a recording medium.

A first aspect of the present invention relates to an image forming apparatus including: a plurality of sensors that detect a state in the image forming apparatus; a power supply that supplies power to each of the plurality of sensors; a current detector that detects a current value of a current supplied from the power supply to each of the plurality of sensors; an acquisitor that acquires, as a reference value, a current value of a current supplied from the power supply to each of the plurality of sensors in a state in which the plurality of sensors are normal, and a determiner that determines whether the plurality of sensors are normal, by comparing the current value detected by the current detector with the reference value.

A second aspect of the present invention relates to a method for determining an abnormality of a sensor in an image forming apparatus including a plurality of sensors that detect a state in the image forming apparatus, a power supply that supplies power to each of the plurality of sensors, and a current detector that detects a current value of a current supplied from the power supply to each of the plurality of sensors, the method including: acquiring, as a reference value, a current value of a current supplied from the power supply to each of the plurality of sensors in a state in which the plurality of sensors are normal; and determining whether the plurality of sensors are normal, by comparing the current value detected by the current detector with the reference value.

A third aspect of the present invention relates to a non-transitory recording medium storing a computer-readable program for causing a computer of an image forming apparatus including a plurality of sensors that detect a state in the image forming apparatus, a power supply that supplies power to each of the plurality of sensors, and a current detector that detects a current value of a current supplied from the power supply to each of the plurality of sensors, to: acquire, as a reference value, a current value of a current supplied from the power supply to each of the plurality of sensors in a state in which the plurality of sensors are normal; and determine whether the plurality of sensors are normal, by comparing the current value detected by the current detector with the reference value.

### BRIEF DESCRIPTION OF THE DRAWINGS

The advantages and features provided by one or more embodiments of the present invention will become more fully understood from the detailed description given hereinbelow and the appended drawings which are given by way of illustration only, and thus are not intended as a definition of the limits of the present invention.

FIG. 1 is a configuration diagram of an image forming apparatus according to an embodiment of the present invention;

FIG. 2 is a block diagram of a controller of the image forming apparatus;

FIG. 3 is a flowchart illustrating an example of sensor abnormality determination processing performed by the image forming apparatus;

FIG. 4 is a flowchart illustrating another example of sensor abnormality determination processing performed by the image forming apparatus;

FIG. 5 is a diagram for explaining a conventional problem; and

FIG. 6 is a diagram for explaining the conventional problem.

### DETAILED DESCRIPTION

Hereinafter, one or more embodiments of the present invention will be described with reference to the drawings. However, the scope of the invention is not limited to the disclosed embodiments.

Hereinafter, an embodiment of the present invention will be described with reference to the drawings.

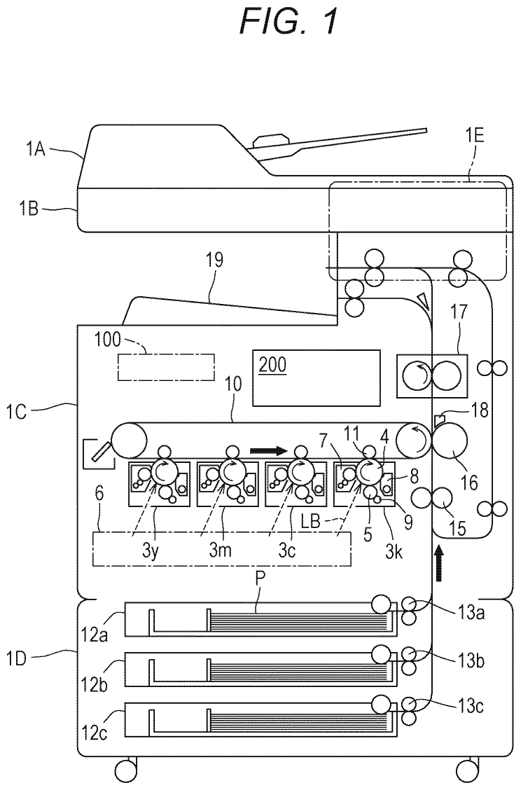

FIG. 1 is a configuration diagram of an image forming apparatus 1 according to an embodiment of the present invention. In this embodiment, as the image forming apparatus 1, a multi-functional peripheral (MFP) in which functions of a copy machine, a printer, a facsimile machine, an image reader, and the like are integrated is used.

The image forming apparatus 1 includes an automatic document feeder (ADF) 1A, a flatbed scanner 1B, a printer section 1C, a sheet feed section 1D, an operation panel section 1E, and the like.

The automatic document feeder 1A conveys a document (sheet) set on a document tray to a reading position of the scanner 1B. The scanner 1B reads an image from a sheet-like document conveyed from the automatic document feeder 1A or various documents set on a platen glass to generate image data.

The printer section 1C forms a color or monochrome image on one or both sides of a sheet (recording sheet) P in a print job, such as copying, network printing (PC-based printing), facsimile reception, or box printing. For example, in a copy job, an image is formed based on image data generated by the scanner 1B.

The printer section 1C includes an electrophotographic tandem-type printer engine. The printer engine includes four imaging units 3y, 3m, 3c, and 3k, a print head 6, an intermediate transfer belt 10, and the like.

The imaging units 3y to 3k each include a cylindrical photoreceptor 4, a charging roller 5, a developing device 7, a cleaner 8, a cleaning roller 9, and a memory (not illustrated) that stores individual information of the photoreceptor 4 and the like. The basic configurations of the imaging units 3y to 3k are the same.

The print head 6 emits a laser beam LB as light for performing pattern exposure on each of the imaging units 3y to 3k. The laser beam LB is a so-called Gaussian beam whose radiation intensity approximately exhibits a Gaussian distribution.

The intermediate transfer belt 10 is a transfer target member in primary transfer of a toner image. The intermediate transfer belt 10 is wound and rotated between a pair of rollers. Inside the intermediate transfer belt 10, a primary transfer roller 11 is disposed for each of the imaging units 3y, 3m, 3c, and 3k.

The sheet feed section 1D includes a plurality of sheet feed cassettes 12a, 12b, and 12c, and takes out a sheet P from a selected one of the sheet feed cassettes and supplies the sheet P to the printer section 1C located above.

In the color printing mode, the imaging units 3y to 3k form toner images of four colors of Y (yellow), M (magenta), C (cyan), and K (black) in parallel. The toner images of four colors are primarily transferred sequentially onto the intermediate transfer belt 10 that is rotating. First, the toner image of Y is transferred, and the toner image of M, the toner image of C, and the toner image of K are sequentially transferred so as to overlap with the toner image of Y. When the primarily transferred toner image faces a secondary transfer roller 16, the toner image is secondarily transferred onto the sheet P conveyed from the sheet feed section 1D via a timing roller 15. Thereafter, the sheet P is discharged by a separation member 18, passes through a fixing device 17, and is sent to a sheet ejection tray 19. When the sheet P passes through the fixing device 17, the toner image is fixed to the sheet P by heat and pressure.

The image forming apparatus 1 includes a controller 100 that controls the entire image forming apparatus 1, a power source 200 that supplies power to each unit, a polygon motor that causes the print head 6 to scan the laser beam LB, a drive motor that drives each unit, and a solenoid that operates each unit.

The sheet feed cassettes 12a, 12b, and 12c of the sheet feed section 1D have sheet feed rollers 13a, 13b, and 13c, respectively, for supplying sheets P to the printer section 1C located above.

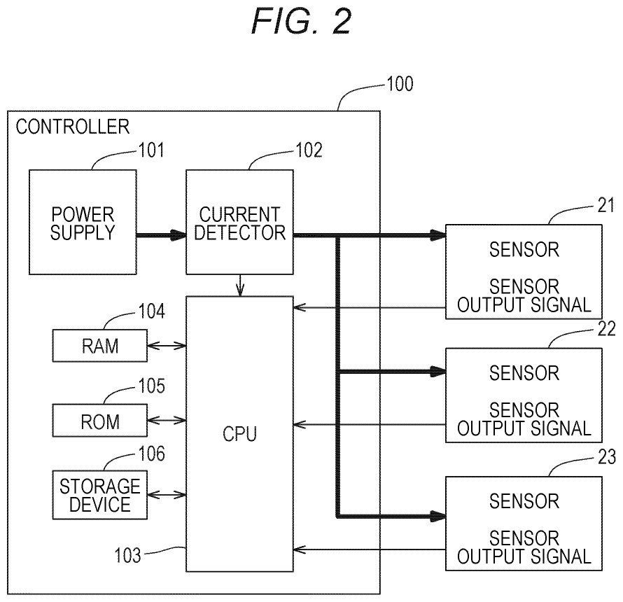

FIG. 2 is a block diagram illustrating a configuration of the controller 100.

The controller 100 includes a power supply 101, a current detector 102, a CPU 103, which is an example of a hardware processor, a RAM 104, a ROM 105, a storage device 106, and the like.

Power (e.g., 5 V) is supplied to the controller 100 from the power source 200. The power supply 101 supplies the power supplied from the power source 200 to each of a plurality of sensors 21 to 23, which are loads, at the voltage of 5 V as it is or supplies the power by stepping down the voltage to, for example, 3.3 V as necessary. In this embodiment, three sensors are used as the plurality of sensors 21 to 23.

Note that in FIG. 2, thick lines indicate current supply lines, and thin lines indicate signal lines.

The use of the plurality of sensors 21 to 23 is not limited, but as an example, a sheet passage sensor that detects the passage of a sheet P conveyed and supplied from each of the sheet feed cassettes 12a, 12b, and 12c to the printer section 1C is exemplified. Alternatively, each of the sensors 21 to 23 may be a sensor for detecting characteristics of the sheet P to determine the sheet type. Furthermore, each of the sensors 21 to 23 may be a sensor for detecting the opening and closing of an opening and closing part of the image forming apparatus 1, and in short, may be any sensor as long as it is used for detecting a state in the image forming apparatus 1.

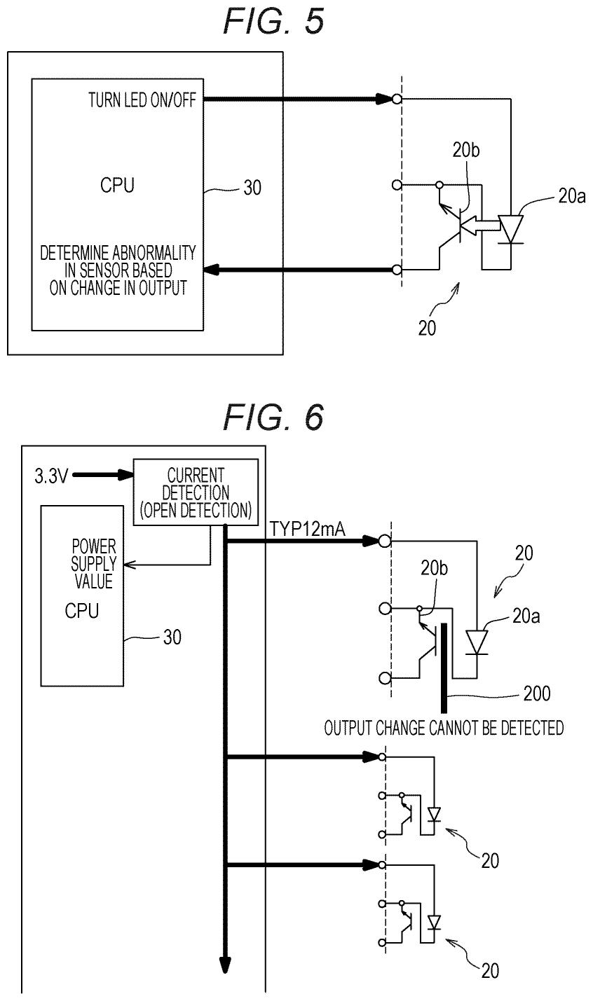

The detection mechanism of each of the sensors 21 to 23 is also not limited. As illustrated in FIGS. 5 and 6, each of the sensors 21 to 23 may be an optical sensor that includes a light emitting element 20a and a light receiving element 20b and detects a detection target by receiving light emitted from the light emitting element 20a at the light receiving element 20b. The optical sensor may be of a reflection type or a transmission type. Further, each of the sensors 21 to 23 may be a magnetic sensor or the like instead of an optical sensor.

The current detector 102 is provided between the power supply 101 and the plurality of sensors 21 to 23. The current detector 102 can detect a total current value that is a sum of currents flowing from the power supply 101 to the plurality of sensors 21 to 23.

The CPU 103 integrally controls the entire image forming apparatus 1. For example, in addition to performing a copying function, a printer function, a scanning function, and the like in response to a user's instruction, the presence or absence of an abnormality of each of the sensors 21 to 23 is particularly determined in this embodiment. To be specific, the CPU 103 acquires a total current value of currents supplied from the power supply 101 to the plurality of sensors 21 to 23 in a state in which the plurality of sensors 21 to 23 are normal, as a reference value at a predetermined timing, and stores the reference value in the storage device 106. Further, the CPU 103 compares the total current value of the plurality of sensors 21 to 23 detected by the current detector 102 with the reference value stored in the storage device 106 at a predetermined timing. Then, the CPU 103 determines the presence or absence of a sensor in which an abnormality has occurred due to a connection failure with a connector, a malfunction, or the like among the plurality of sensors 21 to 23. The sensor abnormality determination processing will be described later.

The RAM 104 is a memory that provides a work area when the CPU 103 operates in accordance with an operation program.

The ROM 105 is a memory for storing the operation program for the CPU 103 and other data.

The storage device 106 includes a hard disk drive (HDD) or a solid state drive (SSD), and stores the above-described reference value, various applications, and other data.

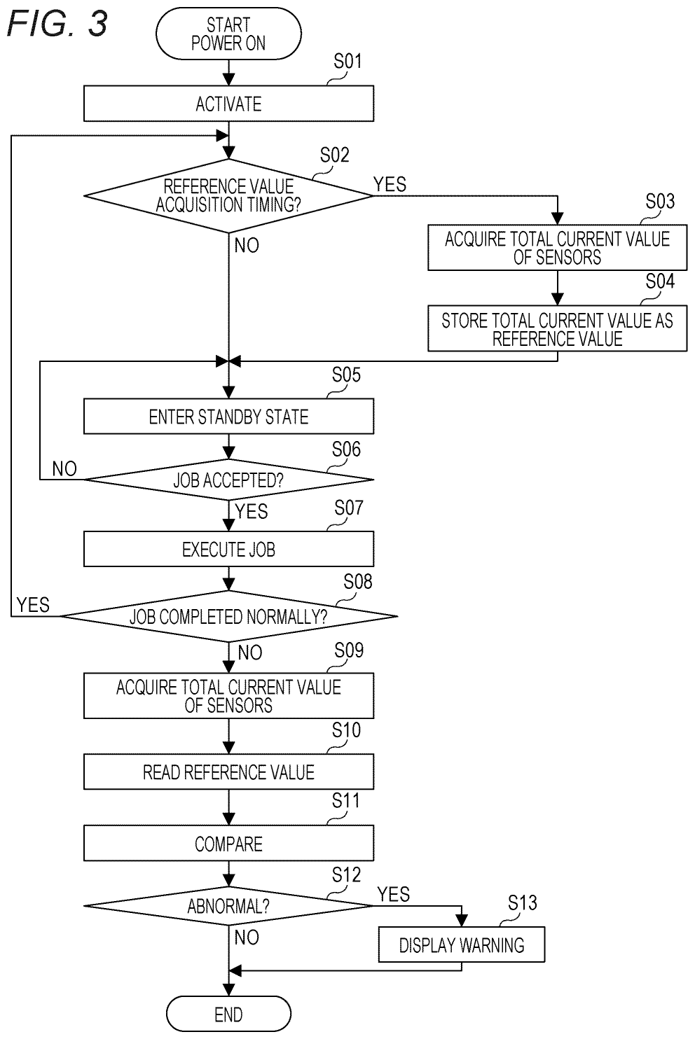

Next, an example of the sensor abnormality determination processing performed by the image forming apparatus 1 will be described with reference to the flowchart of FIG. 3. This determination processing is performed by the CPU 103 operating in accordance with the operation program stored in the ROM 105 or the like.

When the image forming apparatus 1 is turned on, the CPU 103 performs activation processing in step S01. In the activation processing, in this embodiment, the power supply 101 energizes each of the plurality of sensors 21 to 23 and maintains the energized state.

Next, the CPU 103 determines whether it is a reference value acquisition timing. The reference value acquisition timing will be described later.

As described above, the reference value is a total current value of currents supplied from the power supply 101 to the plurality of sensors 21 to 23 in a state in which the plurality of sensors 21 to 23 are normal. In this embodiment, at the time of factory shipment, the reference value is stored in the storage device 106 in advance in a state in which it is confirmed that all the sensors 21 to 23 operate normally. After the start of use of the image forming apparatus 1, the reference value is acquired and updated at a predetermined timing.

Note that the reference value at the time of factory shipment may not exist. In this case, a storage area for the reference value in the storage device 106 may be blank, or a standard value may be stored. However, it is desirable that the reference value at the time of factory shipment is stored because the first abnormality determination processing after the start of use can be performed earlier.

If it is the reference value acquisition timing (YES in step S02), in step S03, the CPU 103 acquires, from the current detector 102, the total current value of the plurality of sensors 21 to 23 detected by the current detector 102. Then, in step S04, the CPU 103 stores the acquired total current value of the plurality of sensors 21 to 23 in the storage device 106 as a reference value, and then enters a standby state in step S05. Therefore, the reference value is updated to a new reference value at every reference value acquisition timing.

If it is not the reference value acquisition timing in step S02 (NO in step S02), the CPU 103 proceeds to step S05 and enters the standby state.

Next, in step S06, the CPU 103 determines whether a job has been accepted. If no job has been accepted (NO in step S06), the standby state is maintained in step S05. If a job has been received (YES in step S06), the CPU executes the job in step S07, and then determines in step S08 whether the job has been completed normally. If the job has been completed normally (YES in step S08), the processing returns to step S02. If the job has not been completed normally (NO in step S08), the processing proceeds to step S09.

The CPU 103 acquires the total current value of the plurality of sensors 21 to 23 from the current detector 102 in step S09, reads the reference value from the storage device 106 in step S10, and then compares the total current value with the reference value in step S11.

As a result of the comparison, the CPU 103 determines the presence or absence of an abnormality of each of the sensors 21 to 23 in step S12. If it is determined that there is no abnormality (NO in step S23), the processing is terminated. If it is determined that there is an abnormality (YES in step S23), in step S13, the CPU 103 displays, on the operation panel or the like, a warning indicating that an abnormality has occurred in at least one of the sensors 21 to 23, to prompt a user to check and replace the at least one of the sensors 21 to 23. The warning may be sent by e-mail to the user. Alternatively, a determination that an abnormality has occurred may be stored in the storage device 106 without displaying a warning.

Here, a specific example of the processing of determining the presence or absence of an abnormality of each of the sensors 21 to 23 will be described.

It is assumed that a reference value stored in the storage device 106 is, for example, a value of 120 mA and a threshold value of a difference between the reference value and a total current value for determining an abnormality is set to 12 mA. When the total current value of the plurality of sensors 21 to 23 detected by the current detector 102 is 120 mA, it is determined that there is no abnormality. On the other hand, when the detected value is a 108 mA, it is estimated that a certain abnormality has occurred in one sensor, and processing is performed such as a warning being displayed or a determination being stored in the storage device 106.

Next, the reference value acquisition timing in step S02 will be described.

As an example of the reference value acquisition timing, there is a timing at which a reference value is acquired based on an instruction given by a user (including a service person) who has confirmed that the image forming apparatus 1 operates normally, through an operation panel or the like. The confirmation of normal operation provides an accurate reference value. In this case, the reference value may be detected by the current detector 102. Alternatively, the user may detect a value using another current detection device and input the detected value through the operation panel or the like, and the input value may be stored as the reference value.

As another example of the reference value acquisition timing, there is a timing at which the number of times of image formation executed by the copy function or the print function reaches a predetermined number of times set in advance. Since the reference value is updated for each predetermined number of times of image formation, even if the current value changes due to a temporal change of each of the sensors 21 to 23, an appropriate reference value corresponding to this change is acquired, and the abnormality determination is made with high accuracy. Examples of the predetermined number of times of image formation include 1000 sheets (1k), 6000 sheets (6k), 10000 sheets (10k), and 20000 sheets (20k).

As still another example of the reference value acquisition timing, there is a timing when at least one of the sensors 21 to 23 is replaced due to replacement of a sheet feed section unit or the like in which the sensors 21 to 23 are mounted. Even if the current value is different between the sensors before and after the replacement, an appropriate reference value corresponding to the current value of the sensor after the replacement is acquired and updated. Note that whether the sensor has been replaced may be automatically determined by the image forming apparatus 1, or may be determined based on a user input.

As yet another example of the reference value acquisition timing, there is a timing when some or all of boards of the controller that controls the sensors 21 to 23 are replaced. In a case where some of or all of the boards of the controller that controls the sensors 21 to 23 are replaced, the value of the detected total current value may vary among the boards. Therefore, an appropriate reference value corresponding to new boards after replacement is acquired and updated.

As yet another example of the reference value acquisition timing, there is a timing at which the plurality of sensors are determined to be in a normal state. That is, in a case where a mode in which the sensors 21 to 23 as to which the presence or absence of an abnormality is to be confirmed operate normally ends in a situation in which the image forming apparatus 1 is usually used, it is determined that the sensors 21 to 23 have no abnormality. Then, in this state, the reference value is acquired and updated.

For example, as illustrated in FIG. 1, in a case where the image forming apparatus 1 includes the three sheet feed cassettes 12a to 12c, a sheet is fed from the lowermost sheet feed cassette 12c. When the sheet P passes through a duplex conveyance path and printing is normally completed, it is determined that all of the sensors 21 to 23 operating in the print mode are normal, and the reference value is acquired and updated.

When it cannot be confirmed that all of the sensors 21 to 23 to be confirmed are normal in a single printing mode, all of the sensors 21 to 23 are operated by a combination of some printing modes to update the reference value. As an example, in a job executed until the image forming apparatus 1 is turned off, when all of “sheet feed from uppermost cassette”, “sheet feed from middle cassette”, “sheet feed from lowermost cassette”, and “double-sided printing” are completed without abnormality, the reference value is acquired and updated.

In a configuration in which the detection states of the sensors 21 to 23 can be changed by operating a motor or the like instead of the normal operation, the reference value is acquired and updated after it is confirmed that the sensors are normal by the operation of the motor or the like. As an example, there is an image forming apparatus including a motor that lifts a sheet in a sheet feed cassette mechanism in which sheets are accommodated, and a sensor that is disposed above the motor and detects that the sheet reaches an upper limit. In this case, by raising or lowering the sheet, it is confirmed that the output of the sensor detecting the upper limit of the sheet operates normally.

In addition, in a case where it is confirmed that all the sensors 21 to 23 of the determination targets are normal by the combination thereof, the reference value is acquired and updated. As an example, in a job executed until the image forming apparatus 1 is turned off, there is a case where all of “sheet feed from uppermost cassette”, “sheet feed from middle cassette”, and “double-sided printing” are finished without abnormality, but it cannot be confirmed that the sensor configured for “sheet feed from lowermost cassette” is normal. In this case, control for operating a sheet lift-up motor for sheet feed from the lowermost cassette is performed, and when it is confirmed that the sensor is normal, the reference value is acquired and updated.

In this embodiment, the current value of the current supplied from the power supply 101 to each of the plurality of sensors 21 to 23 is detected. Furthermore, the current value of the current supplied from the power supply 101 to each of the plurality of sensors 21 to 23 in the state in which the plurality of sensors 21 to 23 are normal is acquired as the reference value. Then, whether the plurality of sensors 21 to 23 are normal is determined by comparison between the detected current value and the acquired reference value.

As a result of the comparison, if the detected current value of each of the plurality of sensors 21 to 23 and the reference value in the state in which the plurality of sensors 21 to 23 are normal are the same or close values, it can be determined that the plurality of sensors 21 to 23 are normal. On the other hand, for example, when the detected current value of each of the plurality of sensors is smaller than the reference value, it can be determined that at least one of the sensors is abnormal. Therefore, it is possible to accurately determine whether the plurality of sensors 21 to 23 are normal, with simple processing.

Moreover, even if there are a variation in circuit constant and an individual difference between sensors, these are equally reflected in both the detected current value and the reference value; therefore, it is also possible to determine that one sensor is abnormal.

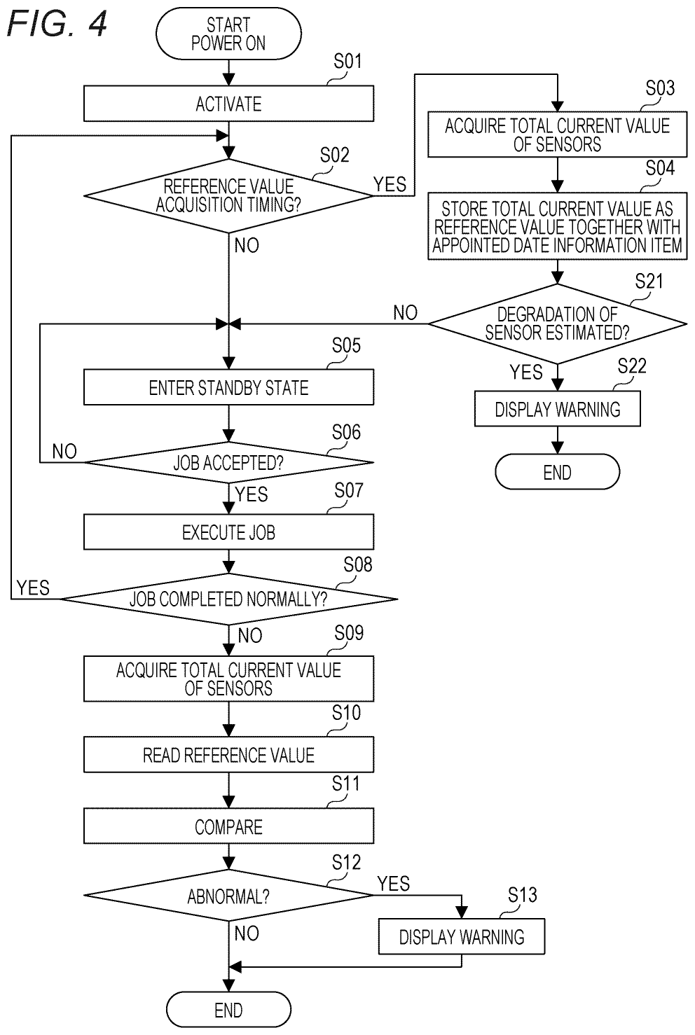

Next, another example of the sensor abnormality determination processing performed by the image forming apparatus will be described with reference to the flowchart of FIG. 4. The determination processing illustrated in this flowchart is also performed by the CPU 103 operating in accordance with the operation program stored in the ROM 105 or the like.

In this determination processing, the CPU 103 stores an appointed date information item in the storage device 106 in addition to the reference value, and accumulates past to latest reference values and appointed date information items. The CPU 103 has a function of predicting a malfunction of at least one of the sensors 21 to 23 based on a temporal change in a reference value obtained from the accumulated reference values and appointed date information items.

More specifically, when the CPU 103 stores the reference value acquired in step S03 of the flowchart of FIG. 4 in the storage device 106 in step S04, the appointed date information item on the date when the reference value was acquired is stored in association with the reference value. At the time of storage, the CPU 103 accumulates the reference values and appointed date information items stored in the past without erasing them.

Next, in step S21, the CPU 103 obtains a temporal change of the reference value from the accumulated reference values and appointed date information items, and determines whether a deterioration (malfunction) of a sensor can be estimated (predicted) from the obtained temporal change. When the CPU 103 cannot estimate the deterioration of at least one of the sensors 21 to 23 (NO in step S21), the CPU 103 proceeds to step S05 and enters the standby state. If the deterioration of at least one of the sensors 21 to 23 can be estimated (YES in step S21), a warning is displayed in step S22 to prompt the user to replace the at least one of the sensors 21 to 23.

The appointed date information item may be the date or the date and time when the reference value was acquired, or may be information such as one month, six months, one year, or two years after the date when the first reference value was acquired (initial value).

In the flowchart of FIG. 4, processes other than step S04, step S21, and step S22 are the same as the processes illustrated in the flowchart of FIG. 3, and thus the description thereof will be omitted. Note that the reference value that the CPU 103 reads from the storage device 106 in step S10 is the latest reference value among the accumulated reference values.

The sensor abnormality determination processing illustrated in the flowchart of FIG. 4 has the following effects in addition to the effects of the abnormality determination processing illustrated in the flowchart of FIG. 3. That is, the presence or absence of an abnormality in at least one of the sensors 21 to 23 is determined based on the temporal change of the total current value of the plurality of sensors 21 to 23 acquired as the reference value. Therefore, the opportunity to determine the presence or absence of an abnormality in at least one of the sensors 21 to 23 increases, and it is possible to stably detect an abnormal sensor.

Note that the timing of determining the presence or absence of an abnormality in at least one of the sensors 21 to 23 based on the temporal change of the total current value of the plurality of sensors 21 to 23 is not limited to the timing illustrated in the flowchart of FIG. 4. For example, the determination may be made after the end of the job.

Although an embodiment of the present invention has been described above, the present invention is not limited to the above-described embodiment. For example, although the abnormality determination processing by comparison of the total current value of the sensors 21 to 23 with the reference value is performed when a job is not completed normally, it may be performed at other timings. Another timing includes a timing at which the image forming apparatus 1 performs an image formation stabilizing operation (image stabilizing operation). The abnormality determination processing may be performed before start or after end of the image stabilizing operation, but is preferably performed during the image stabilizing operation so as not to reduce productivity.

Further, not only the presence or absence of an abnormality in at least one of the sensors is determined from the total current value of all the sensors 21 to 23, but also the following configuration may be adopted. That is, all the sensors 21 to 23 may be divided into a plurality of groups, and the abnormality determination processing by comparison of the total current value and the reference value may be performed on a plurality of sensors belonging to each group. In this case, when an abnormality of a sensor is determined by the comparison between the total current value of all the sensors 21 to 23 and the reference value, the abnormality determination processing is performed for each group, and thus it is easy to specify the abnormal sensor.

In addition, although the CPU 103 compares the total current value of the currents flowing through the plurality of sensors 21 to 23 with the reference value and determines the presence or absence of an abnormality according to the operation program, a comparison circuit or a determination circuit may be configured by hardware.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a plurality of sensors that detect a state in the image forming apparatus;
a power supply that supplies power to each of the plurality of sensors;
a current detector that detects a current value of a current supplied from the power supply to each of the plurality of sensors;
an acquisitor that acquires, as a reference value, a current value of a current supplied from the power supply to each of the plurality of sensors in a state in which the plurality of sensors are normal, and
a determiner that determines whether the plurality of sensors are normal, by comparing the current value detected by the current detector with the reference value.

2. The image forming apparatus according to claim 1, wherein each of the plurality of sensors includes a light emitting element and a light receiving element.

3. The image forming apparatus according to claim 1, wherein the acquisitor acquires the reference value at a time point when manufacture of the image forming apparatus is completed.

4. The image forming apparatus according to claim 1, wherein the acquisitor acquires the reference value based on an instruction from a user of the image forming apparatus.

5. The image forming apparatus according to claim 1, wherein the acquisitor acquires the reference value when a predetermined number of times of image formation is reached in the image forming apparatus.

6. The image forming apparatus according to claim 1, wherein the acquisitor acquires the reference value when at least one of the plurality of sensors is replaced.

7. The image forming apparatus according to claim 1, further comprising
a control board that controls the plurality of sensors,
wherein the acquisitor acquires the reference value when the control board is replaced.

8. The image forming apparatus according to claim 1, wherein the acquisitor acquires the reference value when determining that the plurality of sensors are normal.

9. The image forming apparatus according to claim 1, wherein the determiner determines whether the plurality of sensors are normal during an image formation stabilizing operation in the image forming apparatus.

10. The image forming apparatus according to claim 1, further comprising a predictor that predicts a malfunction of at least one of the plurality of sensors based on a temporal change in the current value detected by the current detector.

11. A method for determining an abnormality of a sensor in an image forming apparatus including a plurality of sensors that detect a state in the image forming apparatus, a power supply that supplies power to each of the plurality of sensors, and a current detector that detects a current value of a current supplied from the power supply to each of the plurality of sensors,
the method comprising:
acquiring, as a reference value, a current value of a current supplied from the power supply to each of the plurality of sensors in a state in which the plurality of sensors are normal; and
determining whether the plurality of sensors are normal, by comparing the current value detected by the current detector with the reference value.

12. A non-transitory recording medium storing a computer-readable program for causing a computer of an image forming apparatus including a plurality of sensors that detect a state in the image forming apparatus, a power supply that supplies power to each of the plurality of sensors, and a current detector that detects a current value of a current supplied from the power supply to each of the plurality of sensors, to:
acquire, as a reference value, a current value of a current supplied from the power supply to each of the plurality of sensors in a state in which the plurality of sensors are normal; and
determine whether the plurality of sensors are normal, by comparing the current value detected by the current detector with the reference value.
